(19) United States
(12) Patent Application Publication
(10) Pub. No.: US 2025/0165488 A1
(43) Pub. Date: May 22, 2025

(54) DATA PROCESSING METHOD AND APPARATUS, DEVICE, AND STORAGE MEDIUM

(71) Applicant: Beijing Zitiao Network Technology Co., Ltd., Beijing (CN)

(72) Inventors: Juan AI, Beijing (CN); Wei FANG, Beijing (CN); Yuxin JING, Beijing (CN); Yi ZHENG, Beijing (CN); Tianyi XIONG, Beijing (CN); Fanshen ZENG, Beijing (CN)

(21) Appl. No.: 18/952,089

(22) Filed: Nov. 19, 2024

(30) Foreign Application Priority Data
Nov. 21, 2023 (CN) 202311559419.6

(51) Int. Cl. G06F 16/248

(52) U.S. Cl. CPC G06F 16/248

(57) ABSTRACT

The present disclosure provides a data processing method and apparatus, a device, and a storage medium. Specifically, if a user needs to search for an object, the user may send object search information, where the object search information may be information of the object to be searched that is described by the user. Next, intention analysis information may be generated based on the object search information and sent to a first model. The first model may analyze an intention of the user based on the intention analysis information to obtain intention information, and send the intention information. Object display information may be generated based on the intention information. The object display information is determined based on information of at least one target object which is matched with the object search information.

### CROSS-REFERENCE TO RELATED APPLICATION

The present application claims priority of the Chinese Patent Application No. 202311559419.6, filed on Nov. 21, 2023, the disclosure of which is incorporated herein by reference in the present application.

### TECHNICAL FIELD

The present disclosure relates to the field of computers, and in particular, to a data processing method and apparatus, a device, and a storage medium.

### BACKGROUND

With the development of computer technologies, more and more enterprises or organizations manage human resources through databases. Specifically, a human resource information database may be established, and related information of employees may be stored in the human resource information database, so that the related information of the employees can be managed through database tools.

However, the above method mainly relies on keyword searches during a process of searching for information, which results in low search efficiency.

### SUMMARY

In order to solve the problem in the art, the present disclosure provides a data processing method and apparatus, a device, and a storage medium.

In view of this, the present disclosure provides technical solutions as follows.

In a first aspect, the present disclosure provides a data processing method. The method includes:
obtaining object search information;
sending intention analysis information to a first model, where the intention analysis information is generated based on the object search information;
receiving intention information sent by the first model, where the intention information is determined based on the object search information; and
generating object display information, where the object display information is determined based on information of at least one target object, the target object is determined based on the intention information, and the target object is matched with the object search information.

In some possible implementations, after the intention information is received and before the object display information is sent, the method further includes:
determining condition information based on the intention information; and
determining the at least one target object based on the condition information, where the information of the target object is matched with the condition information.

In some possible implementations, the intention information includes at least one piece of first-type intention information, and the condition information includes first-type condition information, where the first-type intention information is used to describe the first-type condition information;

the method further comprises:

determining the at least one target object from an object information database, and
the determining the at least one target object from the object information database includes:

determining a first candidate object set from an original object set based on the first-type condition information, where information of an object in the first candidate object set is matched with the first-type condition information; and
determining the at least one target object from the first candidate object set.

In some possible implementations, the intention information further includes at least one piece of second-type intention information, and the condition information further includes second-type condition information, where the second-type condition information is obtained by vectorizing the at least one piece of second-type intention information; and
the determining the at least one target object from the first candidate object set includes:
filtering the first candidate object set to determine a second candidate object set, where a vector of information of an object in the second candidate object set is matched with the second-type condition information; and
determining the at least one target object from the second candidate object set.

In some possible implementations, the intention information further includes at least one piece of third-type intention information, and the condition information further includes third-type condition information;

the determining condition information based on the intention information includes:
performing intention diffusion on the at least one piece of third-type intention information to obtain the third-type condition information; and
the determining the at least one target object from the second candidate object set includes:
filtering the second candidate object set to determine a third candidate object set, where a vector of information of an object in the third candidate object set is matched with the third-type condition information; and
determining the at least one target object from the third candidate object set.

In some possible implementations, the performing intention diffusion on the at least one piece of third-type intention information to obtain the third-type condition information includes:
sending intention diffusion information to a second model, where the intention diffusion information is obtained based on the third-type intention information and instruction information, and the instruction information is used to indicate an intention diffusion rule;
receiving diffusion condition information sent by the second model, where the diffusion condition information is used to indicate a condition that an object satisfying the third-type intention information has; and
determining the third-type condition information based on the diffusion condition information.

In some possible implementations, the third candidate object set includes a third candidate object, and the filtering the second candidate object set to determine a third candidate object set includes:
determining whether information of the third candidate object satisfies the object search information; and
determining the third candidate object as the target object in response to the information of the third candidate object satisfying the object search information.

In some possible implementations, the third candidate object set includes a candidate object, and the determining whether information of the third candidate object satisfies the object search information includes:
obtaining information of the candidate object;
sending object determination information to a third model, where the object determination information is obtained based on the object search information and the information of the candidate object; and
receiving object determination result information sent by the third model, where the object determination result information indicates whether the information of the candidate object satisfies the object search information.

In some possible implementations, the object display information includes summary information of the at least one target object, and before the object display information is sent, the method further includes:
obtaining information of the at least one target object; and
summarizing information of each of the at least one target object to determine summary information of each of the at least one target object.

In some possible implementations, the at least one target object includes a first target object, and the determining summary information of each of the at least one target object includes:
determining first-type display information and second-type display information based on information of the first target object, where a length of the second-type display information is greater than that of the first-type display information;
summarizing the second-type display information; and
determining summary information of the first target object based on the first-type display information and the second-type display information that is summarized.

In some possible implementations, the summarizing the second-type display information includes:
sending original display information to a fourth model, where the original display information is determined based on the second-type display information; and
receiving display summary information sent by the fourth model, where the display summary information includes the second-type display information that is summarized.

In a second aspect, the present disclosure provides a data processing method. The method includes:
receiving a target message in a target conversation, where the target message includes object search information;
determining at least one target object based on the object search information, where the target object is matched with the object search information; and
displaying a reply message in the target conversation, where the reply message includes object display information, and the object display information is obtained based on information of at least one target object.

In some possible implementations, the reply message includes text reply content and an object information list, where the object information list is used to display the information of the at least one target object.

In some possible implementations, the object information list includes at least one information card, where the information card is used to display information of one of the at least one target object.

In some possible implementations, the at least one target object includes N target objects, where N is a positive integer greater than 1; the object information list is used to display information of M target objects, and the reply message further includes an object expand control; and the method further includes:
displaying information of K target objects in the target conversation in response to a first operation triggered for the object expand control, where K is a positive integer, and a sum of M and K is not greater than N.

In some possible implementations, the displaying information of K target objects in the target conversation includes:
displaying the information of the K target objects in the reply message in response to the first operation triggered for the object expand control; or displaying expand information in the target conversation, where the expand information is used to display the information of the K target objects. In a third aspect, the present disclosure provides a data processing apparatus. The apparatus includes:
an obtaining unit configured to obtain object search information;
a first sending unit configured to send intention analysis information to a first model, where the intention analysis information is generated based on the object search information;
a second receiving unit configured to receive intention information sent by the first model, where the intention information is determined based on the object search information; and
a generation unit configured to generate object display information, where the object display information is determined based on information of at least one target object, the target object is determined based on the intention information, and the target object is matched with the object search information.

In some possible implementations, the apparatus further includes a determination unit configured to determine condition information based on the intention information and determine the at least one target object based on the condition information, where the information of the target object is matched with the condition information.

In some possible implementations, the intention information includes at least one piece of first-type intention information, and the condition information includes first-type condition information, where the first-type intention information is used to describe the first-type condition information; and the determination unit is specifically configured to: determine a first candidate object set from an original object set based on the first-type condition information, where information of an object in the first candidate object set is matched with the first-type condition information; and determine the at least one target object from the first candidate object set.

In some possible implementations, the intention information further includes at least one piece of second-type intention information, and the condition information further includes second-type condition information, where the second-type condition information is obtained by vectorizing the at least one piece of second-type intention information; and the determination unit is specifically configured to: filter the first candidate object set to determine a second candidate object set, where a vector of information of an object in the second candidate object set is matched with the second-type condition information; and determine the at least one target object from the second candidate object set.

In some possible implementations, the intention information further includes at least one piece of third-type intention information, and the condition information further includes third-type condition information; and the determination unit is specifically configured to: perform intention diffusion on the at least one piece of third-type intention information to obtain the third-type condition information; filter the second candidate object set to determine a third candidate object set, where a vector of information of an object in the third candidate object set is matched with the third-type condition information; and determine the at least one target object from the third candidate object set.

In some possible implementations, the first sending unit is further configured to send intention diffusion information to a second model, where the intention diffusion information is obtained based on the third-type intention information and instruction information, and the instruction information is used to indicate an intention diffusion rule; the second receiving unit is further configured to receive diffusion condition information sent by the second model, where the diffusion condition information is used to indicate a condition that an object satisfying the third-type intention information has; and the determination unit is further configured to determine the third-type condition information based on the diffusion condition information.

In some possible implementations, the third candidate object set includes a third candidate object, and the determination unit is further configured to determine whether information of the third candidate object satisfies the object search information, and determine the third candidate object as the target object in response to the information of the third candidate object satisfying the object search information.

In some possible implementations, the third candidate object set includes a candidate object, and the first sending unit is further configured to obtain information of the candidate object, and send object determination information to a third model, where the object determination information is obtained based on the object search information and the information of the candidate object; and the second receiving unit is further configured to receive object determination result information sent by the third model, where the object determination result information indicates whether the information of the candidate object satisfies the object search information.

In some possible implementations, the object display information includes summary information of the at least one target object, and the apparatus further includes a processing unit configured to obtain information of the at least one target object, and summarize information of each of the at least one target object to determine summary information of each of the at least one target object.

In some possible implementations, the at least one target object includes a first target object, and the processing unit is specifically configured to: determine first-type display information and second-type display information based on information of the first target object, where a length of the second-type display information is greater than that of the first-type display information; summarize the second-type display information; and determine summary information of the first target object based on the first-type display information and the second-type display information that is summarized.

In some possible implementations, the first sending unit is further configured to send original display information to a fourth model, where the original display information is determined based on the second-type display information; and the second receiving unit is further configured to receive display summary information sent by the fourth model, where the display summary information includes the second-type display information that is summarized.

In a fourth aspect, the present disclosure provides a data processing apparatus. The apparatus includes:
a receiving unit configured to receive a target message in a target conversation, where the target message includes object search information;
a determination unit configured to determine at least one target object based on the object search information, where the target object is matched with the object search information; and
a display unit configured to display a reply message in the target conversation, where the reply message includes object display information, and the object display information is determined based on information of the at least one target object.

In some possible implementations, the reply message includes text reply content and an object information list, where the object information list is used to display the information of the at least one target object.

In some possible implementations, the object information list includes at least one information card, where the information card is used to display information of one of the at least one target object.

In some possible implementations, the at least one target object includes N target objects, where N is a positive integer greater than 1; the object information list is used to display information of M target objects, and the reply message further includes an object expand control; and the display unit is further configured to display information of K target objects in the target conversation in response to a first operation triggered for the object expand control, where K is a positive integer, and a sum of M and K is not greater than N.

In some possible implementations, the display unit is configured to display the information of the K target objects in the reply message in response to the first operation triggered for the object expand control, or display expand information in the target conversation, where the expand information is used to display the information of the K target objects.

In a fifth aspect, the present disclosure provides an electronic device. The electronic device includes:
one or more processors; and
a storage apparatus, on which one or more programs are stored,
the one or more programs, when executed by the one or more processors, cause the one or more processors to implement the method according to any one of the first aspect or implement the method according to any one of the second aspect.

In a sixth aspect, the present disclosure provides a computer-readable storage medium, on which computer programs are stored, the computer programs, when executed by a processor, implement the method according to any one of the first aspect or the method according to any one of the second aspect.

In a seventh aspect, the present disclosure provides a computer program product, the computer program product, when running on a device, causes the device to implement the method according to any one of the first aspect or the method according to any one of the second aspect.

### BRIEF DESCRIPTION OF DRAWINGS

In order to more clearly describe the technical solutions in the embodiments of the present disclosure or in the prior art, the drawings for describing the embodiments or the prior art will be briefly described below. Apparently, the drawings in the description below show merely some embodiments recited in the present disclosure, and those of ordinary skill in the art may still derive other drawings from these drawings without creative efforts.

FIG. 1 is a schematic diagram of an application scenario according to an embodiment of the present disclosure;

FIG. 2 is a schematic flowchart of a data processing method according to an embodiment of the present disclosure;

FIG. 3 is a schematic flowchart of a method for determining a target object according to an embodiment of the present disclosure;

FIG. 4 is a schematic flowchart of another data processing method according to an embodiment of the present disclosure;

FIG. 5 is a schematic diagram of a data processing apparatus according to an embodiment of the present disclosure;

FIG. 6 is a schematic diagram of another data processing apparatus according to an embodiment of the present disclosure; and

FIG. 7 is a schematic diagram of an electronic device according to an embodiment of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish between different objects, apparatuses, modules, or units, and are not used to limit the sequence of functions performed by these objects, apparatuses, modules, or units, or the interdependence of these objects, apparatuses, modules, or units.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

In some scenarios, a user may have a need to view an object having some specific conditions from a plurality of objects. For example, during human resource management, a user may need to select some employees from a plurality of employees. Currently, a user responsible for human resource management may look through a human resource database and select employees who meet requirements.

For example, it is assumed that a new position is vacant, the user responsible for human resource management may need to select an employee to fill the position, or select a plurality of candidates who can fill the position. During this process, the user may look through the human resource database and select a suitable employee based on fields, such as a post, years of service in the company, an education background, and a work experience, in the human resource database.

For another example, if N employees need to be rewarded based on their work performance (where N is a positive integer), the user responsible for human resource management may need to look through the human resource database to view the work performance of candidate employees and select N employees for reward.

For still another example, if labor payment of employees with more than M years of service in the company (where M is a positive integer) needs to be increased, the user responsible for human resource management may need to look through the human resource database to view years of service of the employees in the company and select employees with more than M years of service in the company.

Currently, the user views related information in the human resource database manually. When the human resource database includes information of a large number of employees and/or when information of each employee includes a large number of fields, looking through the human resource database requires a lot of time and effort, which has a problem of low efficiency. In particular, for an organization with a large number of employees, such as a large enterprise, the human resource database may include a plurality of sub-databases, and the user may thus need to switch between the sub-databases, which further reduces the efficiency.

The present disclosure provides a data processing method and apparatus, a device, and a storage medium. Specifically, if a user needs to search for an object, the user may send object search information to a server through a client, where the object search information may be information of the object to be searched that is described by the user. Next, the server may generate intention analysis information based on the object search information and send the intention analysis information to a first model. The first model may analyze an intention of the user based on the intention analysis information to obtain intention information, and send the intention information to the server. The server may determine object display information based on the intention information, and send the object display information to the client. The object display information is determined based on information of the at least one target object which is matched with the object search information. That is, the server may determine, through the first model, the intention of the user who sends the object search information, to determine the target object based on the intention of the user, and send, to the client, the object display information that is determined based on the information of the target object. In this way, the user only needs to input the intention on the client and send the intention to the server, and then the server can determine the intention of the user through the first model and send the object display information that conforms to the intention of the user. Thus, automatic object search is implemented by analyzing the intention of the user, without the need for the user to manually search for the object that conforms to the intention, thereby improving the search efficiency.

In order to solve the problem in the prior art, embodiments of the present disclosure provide a data processing method, which is described in detail below with reference to the drawings of the description.

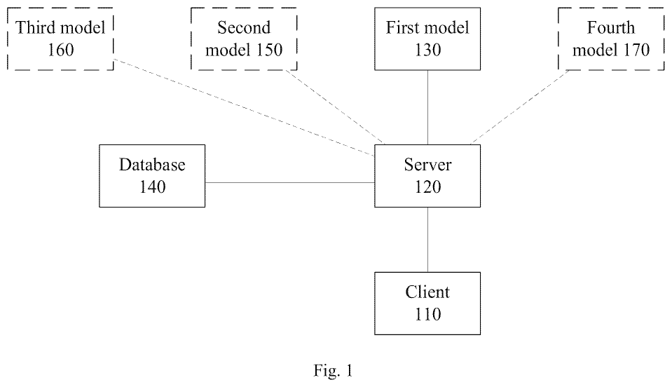

First, an exemplary application scenario of an embodiment of the present disclosure is described. Referring to FIG. 1, FIG. 1 is a schematic diagram of a framework of an exemplary application scenario according to an embodiment of the present disclosure. In the implementation shown in FIG. 1, a client 110, a server 120, a first model 130, and a database 140 are included. The client 110 may be connected to the server 120 through a network, the server 120 may also be connected to the first model 130 through a network, and the server 120 may be connected to the database 140 through a network.

The client 110 may run on a terminal device, such as a mobile phone and a computer of a user. The server 120 may run on a server or a server cluster for providing a service for the client 110. The client 110 may perform data exchange with the server 120.

The first model 130 may run on a server or a server cluster. Optionally, the server (or the server cluster) on which the first model 130 is implemented may be the same as or different from the server (or the server cluster) on which the server 120 is implemented. The first model 130 is used to provide a service of the first model. The server 120 may send data to be processed to the first model 130 for calling the first model 130 to process the data to be processed and send the processed data to the server 120. Optionally, the above first model may be a model having a natural language processing (NLP) function and, for example, may be a language model (LM).

The database 140 may also run on a server or a server cluster to store information related to an object. Optionally, the database 140 may include a human resource database. In addition, the server or the server cluster on which the database 140 runs may be the same as or different from the server or the server cluster on which the server 120 runs.

In some possible implementations provided by the embodiment of the present disclosure, the server may call a plurality of models to determine object display information. Accordingly, in an implementation shown in FIG. 1, a second model 150, a third model 160, and a fourth model 170 may further be included. The second model 150, the third model 160, and the fourth model 170 described above may all be connected to the server 120 through a network. Since the second model 150, the third model 160, and the fourth model 170 are optional, they are indicated by dashed lines in FIG. 1.

The exemplary application scenario of the embodiments of the present disclosure is described above, and an exemplary description of a data processing method according to embodiments of the present disclosure is given below.

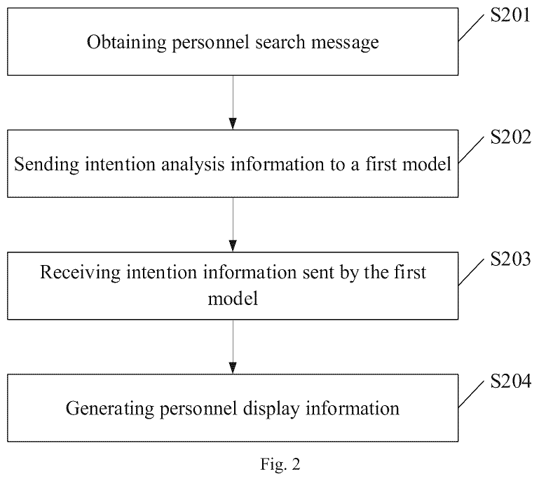

Referring to FIG. 2, FIG. 2 is a schematic flowchart of a data processing method according to an embodiment of the present disclosure. The embodiment of the present disclosure is applicable to an application scenario in which an object is searched for through a client. The data processing method may be executed by a data processing apparatus, and the data processing apparatus may be implemented by software.

Optionally, the data processing apparatus may be integrated in a server of the software. The server of the software may run on a server or a server cluster for providing a corresponding service to a client of the software. Optionally, the software may be instant messaging (IM) software having human resource management capabilities. Accordingly, the client may be a client of the IM software, and the server may be a server of the IM software. A user may send a message to the server of the IM software through the client of the IM software. Optionally, in the application scenario shown in FIG. 1, the data processing apparatus may be integrated in the server 120. As shown in FIG. 2, the method specifically includes the following steps.

S201: obtaining object search information.

In this embodiment of the present disclosure, if the user wants to search for a specific object, the user may send a message to the server through the client, so that the client obtains the object search information. The object search information is used to describe a condition that needs to satisfied by the object to be searched, indicating a need and an intention for the object required to be searched.

In this embodiment of the present disclosure, the object search information may be described based on an unstructured language, that is, the object search information may be unstructured information. Since the object search information is unstructured information, the server may not be able to directly process the object search information. In view of this, the server may call a first model to process the object search information.

Optionally, the object search information may be implemented based on a natural language. That is, when it is required to search for an object that satisfies certain conditions, the user describes the “certain conditions” through the natural language, and sends the natural language description to the server through the client. Alternatively, the object search information may include card information.

In this embodiment of the present application, the object search information may be sent by the client via a target message. A description of the target message may be provided below. Details are not described here.

S202: sending intention analysis information to the first model.

After obtaining the object search information, the server may generate the intention analysis information based on the object search information and send the intention analysis information to the first model.

In some possible implementations, the first model may be a language model, and the intention analysis information may be prompt information. The server may generate the prompt information based on the object search information and send the prompt information to the first model.

In the embodiment of the present disclosure, the first model may be used to analyze the object search information to determine the intention of the user. Accordingly, the intention analysis information may further include instruction information, where the instruction information is used to instruct the first model to analyze the intention of the user based on the object search information.

S203: receiving intention information sent by the first model.

After the first model receives the intention analysis information, the first model may analyze the object search information based on the intention analysis information to obtain the corresponding intention information. The intention information may be used to describe the intention of the user who sends the object search information. That is, the first model may understand the object search information sent by the user to determine what characteristics the user wants to search for an object with.

Optionally, the first model may be a language model, the object search information may be information described in an unstructured language, and the intention information may be information described in a structured language. That is, the intention information may be structured information. Optionally, the intention information may be implemented in a form of a Key-Value pair. The first model may perform semantic analysis on the unstructured object search information to determine the structured intention information. Since the intention information is the structured information, the server may process the intention information.

After determining the intention information, the first model may send intention information to the server, so that the server determines object display information based on the intention information sent by the first model and sends the object display information to the client.

S204: generating the object display information.

After obtaining the intention information sent by the first model, the server may generate the object display information based on the intention information and send the object display information to the client. After receiving the object display information, the client may display the object display information through a display device to the user using the client.

Optionally, the server may determine a target object based on the intention information. Next, the server may obtain related information of the target object from a database based on the target object, and then generate the object display information based on the related information of the target object. That is, the target object is determined based on the intention of the user who sends the object search information, where the intention is obtained through analysis by the first model. Thus, the object display information determined based on the information of the target object can satisfy a need of the user who sends the object search information. A description of the server determining the target object based on the intention information may be provided below, and details are not described here.

That is, the server may determine through the first model the intention of the user who sends the object search information, to determine the target object based on the intention of the user, and send to the client the object display information that is determined based on the information of the target object. In this way, the user only needs to input the intention on the client and send the intention to the server, and then the server can determine the intention of the user through the first model and send the object display information that conforms to the intention of the user. Thus, automatic object search is implemented by analyzing the intention of the user, without the need for the user to manually search for the object that conforms to the intention, thereby improving the search efficiency.

In some possible implementations, the object display information may include information of the at least one target object. Before sending the object display information to the client, the server may obtain information of the at least one target object. For example, the server may obtain the information of the target object from the database.

Optionally, the information of the target object may include a plurality of pieces of information of the target object. For example, the information of the target object may include a plurality of pieces of information such as a work number of the target object, years of service of the target object in the company, work experience of the target object, and professional skill certificate information of the target object. The database may include a human resource database, or other databases for storing human resource information.

Optionally, in order to avoid information leakage, before obtaining the information of the target object from the database, the server may determine whether the user has a permission to obtain the information of the target object. For example, the server may determine whether the user using the client (or an account logged into the client) has a permission to obtain a piece of information of the target object. Optionally, if the client does not have a relevant permission, the server may send prompt information indicating that no result was found. Alternatively, if the user does not have a permission to obtain one (or more) of the plurality of pieces of information, the server may reject querying the information for which the user does not have the permission, and may query information for which the user has the permission.

In some other possible implementations, the object display information may include summary information of the at least one target object. Before sending the object display information to the client, the server may obtain information of the at least one target object, and then determine the summary information of each target object based on the information of the target object. In this way, summarization of the information of the target object may allow the amount of the information sent to the client to be compressed, thereby displaying to the user the information needed.

Optionally, an example in which the target object to be searched is an employee is used for description. When information of an employee A is being summarized, the information of the employee A may be classified. For example, the information of the employee A may be classified into first-type display information and second-type display information. The first-type display information is information that is convenient to be directly displayed on the client, and the second-type display information is information that is not convenient to be directly displayed on the client. For example, the first-type display information may be shorter information such as a name, years of service in the company, and human relations. The second-type display information may be longer information such as work experience and salary information. Generally, a length of the second-type display information may be greater than that of the first-type display information.

After the first-type display information and the second-type display information are determined, the second-type display information may be summarized, and summary information of the employee A may be determined based on the second-type display information that is summarized and the first-type display information. In this way, when the information of the employee A is display on the client, the first-type display information of the employee A and the second-type display information that is summarized of the employee A may be displayed to the user. The first-type display information has not been compressed and is thus convenient for the user to know about clearly. Since the second-type display information has been summarized, the display area required for displaying the summary information of the employee A can be saved.

Optionally, the server may call a model to summarize the second-type display information. Specifically, when summarizing the second-type display information of the employee A, the server may generate original display information based on the second-type display information of the employee A and send the original display information to a fourth model. After obtaining the original display information, the fourth model may summarize the second-type display information, generate display summary information based on the second-type display information that is summarized, and send the display summary information to the server. The server may determine the second-type display information that is summarized based on the display summary information sent by the fourth model. Optionally, the fourth model may be the same as or different from the first model.

Optionally, the original display information may include the prompt information. The original display information may include the second-type display information. The original display information may further include indication information that is used to indicate a rule used by the fourth model to summarize the second-type display information. For example, the indication information may include a word count threshold and example information. The word count threshold is used to limit an upper limit of the length of the second-type display information that is summarized, and the example information is used to show how to summarize the second-type display information.

Optionally, the original display information may further include the object search information. Based on the object search information, the fourth model may summarize content in the second-type display information which has a low correlation with the object search information.

The implementation of the server analyzing the intention of the user through the first model to achieve an automatic object search is described above. In the above embodiment, the first model has a function to determine the intention of the user based on the object search information. It should be understood that after the intention of the user is determined, it is further required to select an object that satisfies the intention of the user. That is, after the server obtains the intention information, the server further needs to determine, based on the intention information, the at least one target object that satisfies the intention information.

Specifically, the server may determine condition information based on the intention information, and then determine, based on the condition information, the target object that satisfies the condition information. The condition information is used to indicate a condition that the target object needs to satisfy. That is, the condition information is used to describe the intention of the user, and may indicate a condition that the object required to be searched by the user needs to satisfy. Optionally, the server may obtain information of objects from a database, and then determine an object whose information is matched with the condition information as the target object.

The implementation of the server determining the at least one target object is described in detail below.

In a first possible implementation, the server may determine the target object through field matching.

If the server determines the target object through field matching, the condition information may include field condition information. The field condition information may also be referred to as first-type condition information, which is used to indicate a condition satisfied by a value of one or more fields of the target object. Specifically, related information of an object may be determined to be a plurality of fields in advance based on a type of the information, where each field may correspond to one piece of related information of the object. For example, an age of the object may correspond to an age field, a gender of the object may correspond to a gender field, and years of service of the object in the company may correspond to a years-of-service field. A value of a field represents an actual situation of the object. For example, a value of the field “years of service” of an employee A represents the years that the employee A has worked in the company.

In the first possible implementation, after determining the intention information through the first model, the server may determine the first-type condition information based on the intention information. Next, the server may determine from the database a field that corresponds to the first-type condition information, and select an object whose value of the field is matched with a value of the first-type condition information as the target object. Optionally, if the first-type condition information is used to indicate values of a plurality of fields, a value of each field of the target object should satisfy that of the first-type condition information.

As an example, it is assumed that the object search information that is input by the user includes “please search for someone who has worked in the company for more than 5 years”. Then, by analyzing the object search information through the first model, it can be determined that the intention of the user is to search an employee who satisfies a condition “years of service in the company >5”. It should be noted that the intention information may be structured information, and the intention of the user is described with a structured language.

Next, the server may determine the first-type condition information based on the intention information sent by the first model. The first-type condition information requires that a value of the field “years of service” of the target employee belongs to “(5, +∞)”.

After determining the first-type condition information, the server may determine the target employee from the database based on the first-type condition information. Specifically, the server may traverse the database, to determine from the database an employee whose value of the field “years of service” belongs to “(5, +∞)”, and determines the employee as the target object.

In a second possible implementation, the server may determine the target object through vector matching.

In actual scenarios, values of some fields may be difficult to match exactly. For example, there may be significant differences between different employees in terms of information such as their work experience information and their professional skill certificate information. In addition, a value of a field may have a complex correlation with an actual need of the user.

For example, it is assumed that a company B1 includes an employee A1 and an employee A2, work experience of the employee A1 includes work experience in a company B2, work experience of the employee A2 includes work experience in company B3, where the company B1 is located in a country C1, the company B2 is located in the country C1, and company B3 is located in a country C2. In this case, if the object search information includes “find someone with experience of working abroad”, by analyzing the object search information through the first model, it can be determined that the intention of the user is to search for an employee whose work experience involves working in a company in a country other than the country C1.

Thus, even if a value of a field “work experience” of the employee A1 is different from a value of the field “work experience” of the employee A2, the employee A1 and the employee A2 both satisfy the need in the object search information. Accordingly, through exact matching of a field value, an employee who satisfies the need may be difficult to find and/or may be missed.

In view of this, in the second possible implementation, the field value may be vectorized, such that the target object is determined by using a vector. This method of determining the target object by using a vector may be referred to as vector matching. If the server determines the target object through vector matching, the condition information may include vector condition information. The vector condition information may also be referred to as second-type condition information, which is used to indicate a condition satisfied by a vector corresponding to a value of one or more fields of the target object.

For example, if the second-type condition information is used to indicate a vector corresponding to a field A, a similarity between a vector corresponding to a value of the field A of the target object and the vector corresponding to the field A indicated by the second-type condition information may be greater than a threshold. The threshold may be a preset threshold, or a threshold in the second-type condition information.

Specifically, values of one or more of a plurality of fields of an object may be vectorized in advance based on a type of the information. For example, the values of the fields such as “work experience” and “salary information” of the object may be vectorized.

It should be understood that if a value of a field supports exact matching, for example, the values of the field can be converted into a specific number, or the value of the field can only be selected from a limited range, the value of such a field may not be vectorized. For example, a value of a field such as “years of service” may not be vectorized. In the embodiment of the present disclosure, a field whose value is vectorized may be referred to as a vectorized field, while a field whose value is not vectorized may be referred to as an exact field or a non-vectorized field.

In actual scenarios, a value of a field may include values for a plurality of segments. Then, during the vectorization, a value for each segment may be vectorized separately. For example, a salary of an employee may have been adjusted multiple times, and then each work experience may be vectorized separately.

After determining the intention information, the server may determine the second-type condition information based on the intention information. Next, the server may select, from the database, an object for which a vector corresponding to a value of a field satisfies the second-type condition information, and the selected object is used as the target object. Optionally, if the second-type condition information is used to indicate vectors corresponding to a plurality of fields, a vector corresponding to a value of each field of the target object satisfies the second-type condition information.

After determining the second-type condition information, the server may determine the target object from the database based on the second-type condition information. Specifically, the server may traverse the database, to determine the target object from the database.

In a third possible implementation, the server may determine the target object through intention diffusion matching.

In actual scenarios, requirements put forward by a user may be generalized. In this case, the intention information determined based on the object search information may be highly generalized, resulting in the server being unable to map the intention information to a specific value of a field or to a vector corresponding to a value of a field. Thus, if only the first-type condition information and/or the second-type condition information are used, the requirement of the user for the target object may not be described.

For example, it is assumed that the object search information includes “who is better in English”. Then, the object search information is analyzed, and the intention information may indicate that the intention of the user is to find an employee with a high level of English language ability. However, it may be difficult to map “English language ability” to a value of a single field or a vector corresponding to the value. For example, an employee who has a professional skill certificate in some aspect of English may be considered as an employee with a high level of English language ability, an employee whose nationality is an English-speaking country may also be considered as an employee with a high level of English language ability, an employee who has work experience in an English-speaking country may also be considered as employees with a high level of English language ability, and an employee whose work experience includes working with another employees from an English-speaking country may also be considered as an employee with a high level of English language ability. It can be learned that since the intention of the user is relatively general, different values of different fields may all satisfy the intention of the user.

In view of this, in the third possible implementation, intention diffusion may be performed on a value of a field, thereby obtaining values of the field that may satisfy the intention of the user or vectors corresponding to the values. The method of determining the target object through intention diffusion may be referred to as intention diffusion matching. If the server determines the target object through intention diffusion matching, the condition information may include intention diffusion condition information. The intention diffusion condition information may also be referred to as third-type condition information, which is used to indicate a condition satisfied by a value of one or more fields of the target object or a vector corresponding to the value.

Specifically, after the intention information is determined through the first model, the intention diffusion may be performed on the intention information to obtain the third-type condition information. During the intention diffusion, it is possible to determine fields through which the intention of the user can be described, and to determine a condition under which values of the fields or vectors corresponding to the values can be matched with the intension of the user.

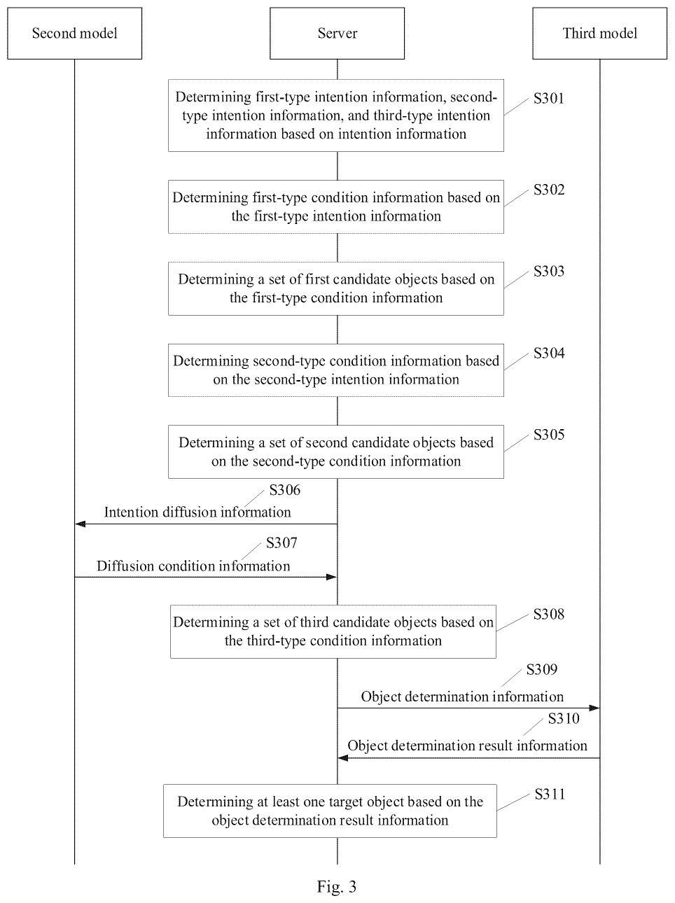

In the embodiment of the present disclosure, the server may perform intention diffusion based on a preset rule. The preset rule is a rule that is preset for intention diffusion, indicating a correlation between the intention information before diffusion and the condition information after diffusion. Alternatively, the server may call a model to perform intention diffusion, for example, the server may call a second model to perform intention diffusion. A description of this part may be provided with reference to FIG. 3, and details are not described here.

For example, it is assumed that the intention of the user is to find an employee with a high level of English language ability. Then, the intention of the user may be diffused to at least three fields such as “nationality”, “professional skill certificate” and “work experience”, etc. In addition, it may further be determined that a value of the field “nationality” may include a value corresponding to English-speaking countries, a value of the field “professional skill certificate” may include professional skill certificates related to English, and a vector corresponding to a value of the field “work experience” may be related to companies in English-speaking countries and/or to positions that require the use of English.

Optionally, the third-type condition information may be used to indicate values of a plurality of fields or vectors corresponding to values of a plurality of fields. A logical relationship between the values of the plurality of fields may be “and” or “or”.

After determining the third-type condition information, the server may determine the target object based on the third-type condition information. Specifically, if the third-type condition information may be used to indicate conditions that need to satisfied by N fields of the target object, the server may determine, for each condition that needs to be satisfied by each field, whether there is an object in the database that satisfies the condition.

Specifically, the third-type condition information may include a plurality of pieces of sub-condition information. A logical relationship between the plurality of pieces of sub-condition information may be “or”. That is, if the object satisfies any one of the plurality of pieces of sub-condition information, it may be determined that the object satisfies the third-type condition information. Accordingly, during determination of the target object, it may be determined for each piece of sub-condition information whether the object satisfies the piece of sub-condition information. If the object satisfies any one piece of sub-condition information, it may be determined that the object satisfies the third-type condition information.

For example, in the above example, the third-type condition information may include: sub-condition information 1, that is, a value of the field “nationality” including values corresponding to English-speaking countries; sub-condition information 2, that is, a value of the field “professional skill certificates” including English-related professional skill certificates; sub-condition information 3, that is, a vector corresponding to a value of the field “work experience” being related to companies in English-speaking countries; and sub-condition information 4, that is, a vector corresponding to the value of the field “work experience” being related to positions that require the use of English.

In the embodiment of the present disclosure, the sub-condition information may be used to indicate a single field or a plurality of fields.

In a first implementation, the sub-condition information may be used to indicate a single field. If a field of an object satisfies a requirement of the sub-condition information, it may be determined that the object satisfies a requirement in the sub-condition information. For example, the sub-condition information may be used for a value of one field; correspondingly, a value of the field of the object satisfying the sub-condition information is matched with the value required by the sub-condition information. For another example, the sub-condition information may be used for a vector corresponding to a value of one field; correspondingly, a vector corresponding to a value of the field of the object satisfying the sub-condition information is matched with the vector required by the sub-condition information.

In a second implementation, the sub-condition information is used to indicate a plurality of fields. if a plurality of fields of an object all satisfy requirements in the sub-condition information, it may be determined that the object satisfies the sub-condition information. For example, the first sub-condition information may be used to indicate values of a plurality of fields, or the first sub-condition information may be used to indicate vectors corresponding to values of a plurality of fields, or the first sub-condition information may be used to indicate a value of at least one field and a vector corresponding to the value of the at least one field.

It should be noted that the above two implementations may both exist. For example, some of the plurality of pieces of sub-condition information included in the third-type condition information may indicate a single field, while some of the pieces of sub-condition information may be used to indicate a plurality of fields.

It should be noted that the above three implementations are only examples. In actual scenarios, other implementations may be used to determine the target object, or the above three implementations may be combined to determine the target object. For example, the intention of the user is complex, in that it includes all of an intention that may be described through the first-type condition information, an intention that may be described through the second-type condition information, and an intention that may be described through the third-type condition information. Then, the server may combine the three types of condition information to determine the target object. Details may be provided below in a description of the implementation corresponding to FIG. 3, and are not described here.

In actual scenarios, the target object determined based on the condition information may not satisfy the need in the object search information. For example, if the client performs intention diffusion on the intention information, the condition information obtained through intention diffusion may not satisfy the need in the object search information. In view of this, the server may determine at least one possible target object based on the condition information, and then determine whether the at least one possible target object satisfies the need in the object search information. For example, the server may call a third model to determine whether the possible target object satisfies the need in the object search information. A description of this part may be provided with reference to FIG. 3, and details are not described here.

Various implementations of determining the target object are described above, which are described in detail below with reference to FIG. 3.

Referring to FIG. 3, FIG. 3 is a schematic diagram of an implementation of determining a target object according to an embodiment of the present disclosure. In the implementation corresponding to FIG. 3, a server may combine first-type condition information, second-type condition information and third-type condition information to determine the target object.

As shown in FIG. 3, the method specifically includes the following steps.

In S301, the server determines the first-type intention information, the second-type intention information, and the third-type intention information based on intention information.

In the embodiment of the present disclosure, the server may call a first model to analyze object search information to determine the intention information. After determining the intention information, the server may further determine the first-type intention information, the second-type intention information and the third-type intention information based on the intention information. The first-type intention information corresponds to first-type condition information, the second-type intention information corresponds to second-type condition information, and the third-type intention information corresponds to a third-type condition information.

Specifically, an intention information analysis rule may be preset. The intention information analysis rule is used to analyze the intention information. After obtaining the intention information, the server may divide the intention information into a plurality of pieces of intention sub-information. Next, the server may determine whether the intention sub-information is the first-type intention information, the second-type intention information, or the third-type intention information based on the intention information analysis rule.

For example, the intention analysis information may include a first type of keywords and a second type of keywords. If there is a match between the intention sub-information and the first type of keywords, the intention sub-information may be determined as the first-type intention information. If there is a match between the intention sub-information and the second type of keywords, the intention sub-information may be determined as the second-type intention information. If there is no match between the intention sub-information and the first type of keywords as well as the second type of keywords, the intention sub-information may be determined as the third-type intention information. The first type of keywords may be predetermined keywords that may be present in the first-type intention information, and the second type of keywords may be predetermined keywords that may be present in the second-type intention information.

In actual scenarios, the intention information may only include one or two of the first-type intention information, the second-type intention information, and the third-type intention information, or may include all of the first-type intention information, the second-type intention information, and the third-type intention information. For ease of description, an example in which the intention information including the first-type intention information, the second-type intention information, and the third-type intention information is used below for description.

In S302, the server determines the first-type condition information based on the first-type intention information.

After determining the first-type intention information, the server may determine the first-type condition information based on the first-type intention information.

In S303, the server determines a first candidate object set based on the first-type condition information.

After determining the first-type condition information, the server may filter objects based on the first-type condition information to determine the first candidate object set. The first candidate object set may include at least one first candidate object. The first candidate object satisfies the first-type condition information.

In S304, the server determines the second-type condition information based on the second-type intention information.

After determining the second-type intention information, the server may determine the second-type condition information based on the second-type intention information.

Optionally, step S304 may be performed before step S303, or after step S303, or at the same time as step S303, which is not limited in the embodiment of the present disclosure.

In S305, the server filters the first candidate object set based on the second-type condition information to determine a second candidate object set.

After determining the second-type condition information and determining the first candidate object set, the server may filter the first candidate object set based on the second-type condition information, to determine at least one second candidate object from the first candidate object set, thereby obtaining the second candidate object set.

Specifically, the second candidate object satisfies both the first-type condition information and the second-type condition information.

In S306, the server sends intention diffusion information to a second model.

In the implementation corresponding to FIG. 3, the server may call the second model to determine the third-type condition information. Specifically, the server may generate the intention diffusion information based on the third-type intention information, and send the intention diffusion information to the second model. The second model is used to perform intention diffusion on the third-type intention information. Optionally, the second model may be a model with NLP capabilities, and the intention diffusion information may be prompt information. In some possible implementations, the second model may be the same as or different from the first model and the fourth model as mentioned above.

Specifically, the intention diffusion information may include the third-type intention information. The intention diffusion information may further include indication information and/or example information. The indication information is used to indicate the second model to perform intention diffusion based on the third-type intention information. The example information may be used as an example to direct the second model to perform intention diffusion. For example, the example information may include the intention information before diffusion and the intention information after diffusion.

The second model may perform intention diffusion on the third-type intention information based on the intention diffusion information to determine a condition satisfied by a value of one or more fields of the target object or a vector corresponding to the value. After the intention diffusion, the second model may send diffusion condition information to the server. The diffusion condition information is used to indicate a condition of an object satisfying the third-type intention information. Optionally, the diffusion condition information may include the third-type condition information.

In S307, the server receives the diffusion condition information sent by the second model, and determines the third-type condition information based on the diffusion condition information.

The second model may send the diffusion condition information to the server, and the server may receive the diffusion condition information sent by the second model and determine the third-type condition information based on the diffusion condition information. Optionally, step S306 and step S307 may be performed before step S303, or after step S303, or at the same time as step S303, which is not limited in the embodiments of the present disclosure.

In S308, the server filters the second candidate object set based on the third-type condition information to determine a third candidate object set.

After determining the third-type condition information and determining the second candidate object set, the server may further filter the second candidate object set based on the third-type condition information to determine at least one third candidate object from the first candidate object set, thereby obtaining the third candidate object set.

The third candidate object satisfies all of the first-type condition information, the second-type condition information, and the third-type condition information.

In S309, the server sends object determination information to a third model.

After determining the third candidate object set, the server may generate the object determination information and send the object determination information to the third model. The object determination information includes related information of the at least one third candidate object, and further includes the object search information. The third model may determine for each third candidate object whether the third candidate object satisfies a requirement in the object search information.

Specifically, if the third candidate object satisfies the requirement in the object search information, it is indicated that the third candidate object can satisfy a need of a user, and thus may be determined as the target object for display to the user. If the third candidate object does not satisfy the requirement in the object search information, it is indicated that the third candidate object does not satisfy a need of a user, and thus cannot be determined as the target object for display to the user. In this way, determination through the third model may avoid problems such as AI hallucinations, etc.

Optionally, the third model may be a model with NLP capabilities, and the object determination information may be prompt information. Optionally, the third model may be the same as or different from the first model, the second model, and the fourth model as mentioned above.

In S310, the server receives the object determination result information sent by the third model.

After the determination based on the object determination information, the third model may generate object determination result information. The object determination result information is used to indicate that the third candidate object can be determined as the target object. The third model may send the object determination result information to the server. The server may obtain the object determination result information from the third model.

In S311, the server determines the at least one target object based on the object determination result information.

The server may determine, based on the object determination result information sent by the third model, whether the third candidate object in the third candidate object set satisfies the object search information. The server may determine the third candidate object that can satisfy the object search information as the target object, to complete the determination of the target object.

In the implementation corresponding to FIG. 3, the server may determine the target object through multiple filtrations, which can improve the accuracy of the target object, thereby enabling the determined target object to better meet the need of the user. In addition, by calling models multiple times, a degree of match between the target object and the need of the user can be further improved.

Some implementations of the server searching for the target object based on the object search information sent by the client are described above. A data processing method performed by the client during this process is described below.

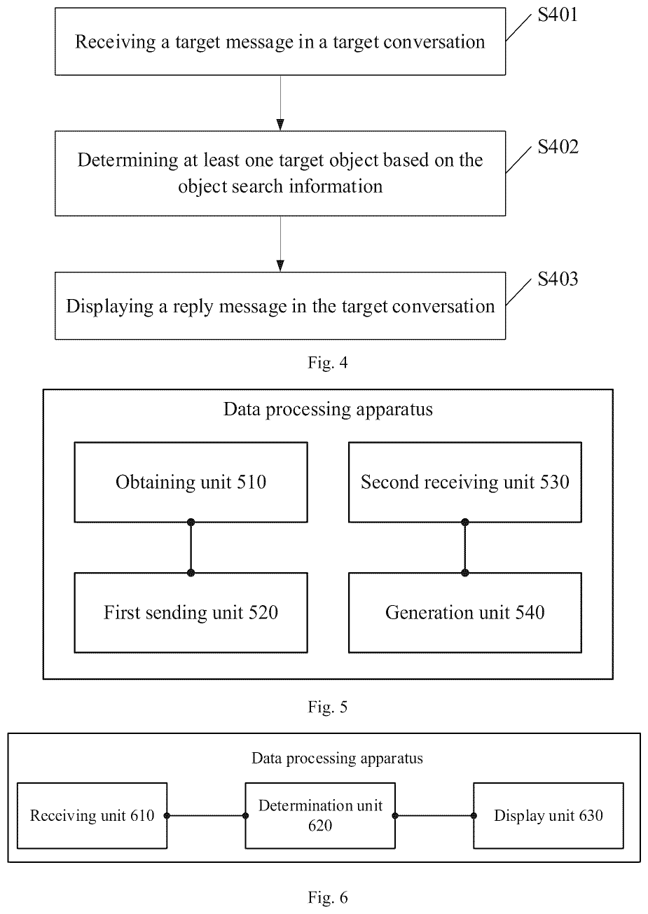

Referring to FIG. 4, FIG. 4 is a schematic diagram of an implementation of determining a target object according to an embodiment of the present disclosure. In the implementation corresponding to FIG. 4, the client may call a client to search for the target object, and display information of the target object to a user.

As shown in FIG. 4, the method specifically includes the following steps.

S401: receiving a target message in a target conversation.

If the user wants to search for the target object through the client, the user may send the target message in an encoding session through the client. The target message includes object search information indicating a condition satisfied by the target object that the user wants to search for.

Optionally, if the client is a client of IM software, and the server is a server of the IM software, the target message may be an IM message, and the target conversation may be an IM conversation.

In this embodiment of the present disclosure, the target conversation may be an IM one-on-one conversation or an IM group conversation. That is, the user may send the target message in the IM one-on-one conversation or the IM group conversation. The two cases are respectively described below.

In a first implementation, the target conversation is the IM one-on-one conversation.

Optionally, the user may send the target message through an IM one-on-one conversation corresponding to an intelligent assistant. The intelligent assistant may be a preset interface of a service associated with a first model. For example, the intelligent assistant may be a preset IM dialogue robot. The IM message sent by the user to the intelligent assistant may be forwarded by the server to the first model.

Alternatively, the user may send the target message in another IM one-on-one conversation, and wake up the intelligent assistant to analyze the target message. Accordingly, after obtaining the operation triggered by the user to wake up the intelligent assistant to analyze the target message, the client may send the target message to the server, so that the server calls the first model to analyze the object search information. For the description of this part, reference may be made to the above, and details are not repeated here.

In a second implementation, the target message is sent by the user in the IM group conversation.

Optionally, the user may send the target message in the IM group conversation, and wake up an intelligent assistant to analyze the target message. Accordingly, after obtaining the operation triggered by the user to wake up the intelligent assistant to analyze the target message, the client may send object search information to the server, so that the server calls a first model to analyze the object search information.

Specifically, the user may send the target message in the IM group conversation through the IM message. Next, the user may trigger an operation of waking up the intelligent assistant for the IM message to analyze the IM message. For example, the user may first trigger a right-click operation on the IM message to wake up the client to display an operation control menu. Next, the user may trigger an operation on a control corresponding to the intelligent assistant in the operation control menu to trigger the intelligent assistant to analyze the object search information in the IM message.

S402: determining at least one target object based on the object search information.

After receiving the target message, the client may call the server to determine at least one target object based on the object search information. For the description of this part, reference may be made to the above, and details are not repeated here.

S403: displaying a reply message in the target conversation.

After the target object is determined by the server, the client may generate the reply message based on the information of the target object and display the reply message in the target conversation, so that the user views the reply message to know about the information of the target object.

Optionally, the reply message may include text reply content and an object information list. The text reply content is used to indicate that the reply message is reply content to the target message. The object information list is used to display the information of the target object.

Optionally, the object information list may include one or more information cards, each of which may be used to display one piece of target object information. Optionally, if there are a plurality of target objects, the client may display a plurality of message cards, each of which is used to display related information of one target object. Alternatively, the message card displayed by the client may include a plurality of sub-cards, each of which is used to display related information of one target object.

Optionally, if the object search information is sent by the user in the IM one-on-one conversation corresponding to the intelligent assistant, the client may display the message card in the current IM conversation. Alternatively, if the object search information is sent by the user in an IM one-on-one conversation that does not correspond to the intelligent assistant, the client may display the message card in the current IM conversation, or may jump to the IM one-on-one conversation corresponding to the intelligent assistant and display the message card in the IM one-on-one conversation corresponding to the intelligent assistant.

In actual scenarios, there may be a large number of target objects. Displaying the information of all the target objects at a time in this way may not be convenient for the user to view. In addition, the server may need more network resources to send the related information of all the target objects at a time to the client. In view of this, in some possible implementations, the object display information that may be sent by the server to the client may be generated based on information of some of the target objects, and the client may display related information of these target objects to the user.

For example, it is assumed that the server determines N target objects (where N is a positive integer) based on the intention information. Then, the server may first select M target objects (where M is a positive integer less than N) from the N target objects, and then generate the object display information based on information of the selected M target objects and send the object display information to the client. In this way, the client may display only the information of the M target objects, without having to display the information of the N target objects at a time.

In the above example, the server may determine, based on relevance between a target object and the object search information, a target object of which related information is displayed. For example, the selected M target objects may be M target objects with the highest relevance to the object search information among the N target objects. Optionally, the relevance between a target object and the object search information may be determined based on a model. For example, the relevance between a target object and the object search information may be determined through a third model as described below (or another model). A description of this part may be provided below, and details are not described here.

If the client displays the related information of some of the target objects to the user, in some scenarios, the target objects displayed by the client to the user may not meet a need of the user. Thus, the user may want to view another target object. In view of this, when displaying the related information of some of the target objects, the client may further display an object expand control. After the user triggers the object expand control, the client may send a data obtaining request to the server. The server may generate new object display information based on the data obtaining request sent by the client and send the new object display information to the client. The new object display information may be determined based on the related information of all the target objects.

A description is made continuing with the above example in which it is assumed that the server determines N target objects, and the client displays M target objects. After the user triggers an expand operation, the client may display information of K target objects in the target conversation. A sum of M and K is not greater than N.

Optionally, the server may display the information of the K target objects in addition to the reply message, or display a new message in the target conversation and display the information of the K target objects through the new message. The new message may be referred to as expand information.

In the implementation described above, the server may send related information of some of the target objects to the client, and then send related information of other target objects to the client based on the operation triggered by the user. However, in some other possible implementations, the server may alternatively send the related information of all the target objects to the client, and the client may only display the related information of some of the target objects at a time, and may display related information of other target objects after the user triggers the operation.

In some implementations, there may be a large amount of the related information of the target object. Thus, a larger display area may be required to fully display the related information of the target object. This may affect the user experience of the user using the client. In view of this, in some implementations, the related information of the target object may be displayed in a truncated form. Then, after the information expand display operation triggered by the user is obtained, complete related information of the target object may be displayed to the user.

For example, a word count threshold and/or a line count threshold may be preset. If a word count of a piece of related information of the target object reaches the word count threshold and/or its line count reaches the line count threshold, the client may display the related information in a truncated form. For example, related information within the word count threshold may be displayed, and/or related information within the line count threshold may be displayed. Optionally, the client may further display an information expand control, and the user may trigger an information expand operation through the information expand control.

After obtaining the information expand operation triggered by the user for a piece of related information of the target object, the client may display the complete related information. For example, the client may expand a display area of the current page that is used to display this piece of related information, so that the complete related information may be displayed by using a larger display area. Alternatively, the client may jump to another page or pop up a sub-page to display the complete related information in the page that is jumped to or pops up.

Based on the data processing method provided in the above method embodiments, embodiments of the present disclosure further provide a data processing apparatus that may run on a server. The data processing apparatus is described below with reference to the drawing.

Referring to FIG. 5, FIG. 5 is a schematic structure diagram of a data processing apparatus according to an embodiment of the present disclosure. As shown in FIG. 5, the data processing apparatus includes:
an obtaining unit 510 configured to receive object search information sent by a client;
a first sending unit 520 configured to send intention analysis information to a first model, where the intention analysis information is generated based on the object search information;
a second receiving unit 530 configured to receive intention information sent by the first model, where the intention information is determined based on the object search information; and
a generation unit 540 configured to send object display information to the client, where the object display information is determined based on information of at least one target object, the target object is determined based on the intention information, and the target object is matched with the object search information.

In some possible implementations, the apparatus further includes a determination unit configured to determine condition information based on the intention information and determine the at least one target object based on the condition information, where the information of the target object is matched with the condition information.

In some possible implementations, the intention information includes at least one piece of first-type intention information, and the condition information includes first-type condition information, where the first-type intention information is used to describe the first-type condition information; and the determination unit is specifically configured to: determine a first candidate object set from an original object set based on the first-type condition information, where information of an object in the first candidate object set is matched with the first-type condition information; and determine the at least one target object from the first candidate object set.

In some possible implementations, the intention information further includes at least one piece of second-type intention information, and the condition information further includes second-type condition information, where the second-type condition information is obtained by vectorizing the at least one piece of second-type intention information; and the determination unit is specifically configured to: filter the first candidate object set to determine a second candidate object set, where a vector of information of an object in the second candidate object set is matched with the second-type condition information; and determine the at least one target object from the second candidate object set.

In some possible implementations, the intention information further includes at least one piece of third-type intention information, and the condition information further includes third-type condition information; and the determination unit is specifically configured to: perform intention diffusion on the at least one piece of third-type intention information to obtain the third-type condition information; filter the second candidate object set to determine a third candidate object set, where a vector of information of an object in the third candidate object set is matched with the third-type condition information; and determine the at least one target object from the third candidate object set.

In some possible implementations, the first sending unit 520 is further configured to send intention diffusion information to a second model, where the intention diffusion information is obtained based on the third-type intention information and instruction information, and the instruction information is used to indicate an intention diffusion rule; the second receiving unit 530 is further configured to receive diffusion condition information sent by the second model, where the diffusion condition information is used to indicate a condition that an object satisfying the third-type intention information has; and the determination unit is further configured to determine the third-type condition information based on the diffusion condition information.

In some possible implementations, the third candidate object set includes a third candidate object, and the determination unit is further configured to determine whether information of the third candidate object satisfies the object search information, and determine the third candidate object as the target object in response to the information of the third candidate object satisfying the object search information.

In some possible implementations, the third candidate object set includes a candidate object, and the first sending unit 520 is further configured to obtain information of the candidate object, and send object determination information to a third model, where the object determination information is obtained based on the object search information and the information of the candidate object; and the second receiving unit 530 is further configured to receive object determination result information sent by the third model, where the object determination result information indicates whether the information of the candidate object satisfies the object search information.

In some possible implementations, the object display information includes summary information of the at least one target object, and the apparatus further includes a processing unit configured to obtain information of the at least one target object, and summarize information of each of the at least one target object to determine summary information of each of the at least one target object.

In some possible implementations, the at least one target object includes a first target object, and the processing unit is specifically configured to: determine first-type display information and second-type display information based on information of the first target object, where a length of the second-type display information is greater than that of the first-type display information; summarize the second-type display information; and determine summary information of the first target object based on the first-type display information and the second-type display information that is summarized.

In some possible implementations, the first sending unit 520 is further configured to send original display information to a fourth model, where the original display information is determined based on the second-type display information; and the second receiving unit 530 is further configured to receive display summary information sent by the fourth model, where the display summary information includes the second-type display information that is summarized.

Based on the data processing method provided in the above method embodiments, embodiments of the present disclosure further provide a data processing apparatus that may run on a client. The data processing apparatus is described below with reference to the drawing.

Referring to FIG. 6, FIG. 6 is a schematic structure diagram of a data processing apparatus according to an embodiment of the present disclosure. As shown in FIG. 6, the data processing apparatus includes:
a receiving unit 610 configured to receive a target message in a target conversation, where the target message includes object search information;
a determination unit 620 configured to determine at least one target object based on the object search information, where the target object is matched with the object search information; and
a display unit 630 configured to display a reply message in the target conversation, where the reply message includes object display information, and the object display information is determined based on information of the at least one target object.

In some possible implementations, the reply message includes text reply content and an object information list, where the object information list is used to display the information of the at least one target object.

In some possible implementations, the object information list includes at least one information card, where the information card is used to display information of one of the at least one target object.

In some possible implementations, the at least one target object includes N target objects, where N is a positive integer greater than 1; the object information list is used to display information of M target objects, and the reply message further includes an object expand control; and the display unit 630 is further configured to display information of K target objects in the target conversation in response to a first operation triggered for the object expand control, where K is a positive integer, and a sum of M and K is not greater than N.

In some possible implementations, the display unit 630 is configured to display the information of the K target objects in the reply message in response to the first operation triggered for the object expand control, or display expand information in the target conversation, where the expand information is used to display the information of the K target objects.

Based on the data processing method provided in the above method embodiment, the present disclosure further provides an electronic device. The electronic device includes: one or more processors; and a storage apparatus, on which one or more programs are stored thereon, and the one or more programs, when executed by the one or more processors, cause the one or more processors to implement the data processing method according to any one of the above embodiments.

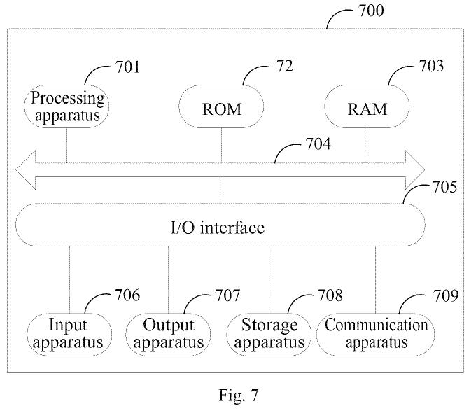

Reference is made to FIG. 7 below, which is a schematic diagram of a structure of an electronic device 700 suitable for implementing embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (Portable Android Device, PAD), a portable multimedia player (PMP), and a vehicle-mounted terminal (such as a vehicle navigation terminal), and fixed terminals such as a digital television (TV) and a desktop computer. The electronic device in the figure is merely an example, and shall not impose any limitation on the function and scope of use of the embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to embodiments of the present disclosure, the process described above with reference to the flowchart may be implemented as a computer software program. For example, the embodiments of the present disclosure provide a computer program product, which includes a computer program carried on a non-transitory computer-readable storage medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the method of the embodiment of the present disclosure are performed.

The electronic device according to embodiments of the present disclosure and the data processing method and file sending method according to the above embodiments belong to the same inventive concept. For the technical details not exhaustively described in the embodiments, reference may be made to the above embodiments, and the embodiments and the above embodiments have the same beneficial effects.

Based on the method provided in the above method embodiment, embodiments of the present disclosure provide a computer storage medium, on which computer programs are stored, and the computer programs, when executed by a processor, implement the data processing method according to any one of the above embodiments to be implemented.

It should be noted that the above computer-readable storage medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable storage medium other than the computer-readable storage medium. The computer-readable signal medium can send, propagate, or transmit a program used by or in combination with an instruction execution system, apparatus, or device. The program code contained in the computer-readable storage medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable storage medium may be contained in the above electronic device. Alternatively, the computer-readable medium may exist independently, without being assembled into the electronic device.

The above computer-readable storage medium carries one or more programs, and the one or more programs, when executed by the electronic device, cause the electronic device to perform the above data processing method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit/module does not constitute a limitation on the unit itself in some cases. For example, a voice data collection module may alternatively be described as a “data collection module”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable storage medium may be a tangible medium that may contain or store a program used by or in combination with an instruction execution system, apparatus, or device. The machine-readable storage medium may be a machine-readable signal medium or a machine-readable storage medium. The machine-readable storage medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. A data processing method, comprising:
obtaining object search information;
sending intention analysis information to a first model, wherein the intention analysis information is generated based on the object search information;
receiving intention information sent by the first model, wherein the intention information is determined based on the object search information; and
generating object display information, wherein the object display information is determined based on information of at least one target object, the target object is determined based on the intention information, and the target object is matched with the object search information.

2. The method according to claim 1, wherein after the intention information is received and before the object display information is sent, the method further comprises:
determining condition information based on the intention information; and
determining the at least one target object based on the condition information, wherein the information of the target object is matched with the condition information.

3. The method according to claim 2, wherein the intention information comprises at least one piece of first-type intention information, and the condition information comprises first-type condition information, wherein the first-type intention information is used to describe the first-type condition information;
the method further comprises:
determining the at least one target object from an object information database, and
the determining the at least one target object from the object information database comprises:
determining a first candidate object set from an original object set based on the first-type condition information, wherein information of an object in the first candidate object set is matched with the first-type condition information; and
determining the at least one target object from the first candidate object set.

4. The method according to claim 3, wherein the intention information further comprises at least one piece of second-type intention information, and the condition information further comprises second-type condition information, wherein the second-type condition information is obtained by vectorizing the at least one piece of second-type intention information; and
the determining the at least one target object from the first candidate object set comprises:
filtering the first candidate object set to determine a second candidate object set, wherein a vector of information of an object in the second candidate object set is matched with the second-type condition information; and
determining the at least one target object from the second candidate object set.

5. The method according to claim 4, wherein the intention information further comprises at least one piece of third-type intention information, and the condition information further comprises third-type condition information;
the determining condition information based on the intention information comprises:
performing intention diffusion on the at least one piece of third-type intention information to obtain the third-type condition information; and
the determining the at least one target object from the second candidate object set comprises:
filtering the second candidate object set to determine a third candidate object set, wherein a vector of information of an object in the third candidate object set is matched with the third-type condition information; and
determining the at least one target object from the third candidate object set.

6. The method according to claim 5, wherein the performing intention diffusion on the at least one piece of third-type intention information to obtain the third-type condition information comprises:
sending intention diffusion information to a second model, wherein the intention diffusion information is obtained based on the third-type intention information and instruction information, and the instruction information is used to indicate an intention diffusion rule;
receiving diffusion condition information sent by the second model, wherein the diffusion condition information is used to indicate a condition that an object satisfying the third-type intention information has; and
determining the third-type condition information based on the diffusion condition information.

7. The method according to claim 5, wherein the third candidate object set comprises a third candidate object, and the filtering the second candidate object set to determine a third candidate object set comprises:
determining whether information of the third candidate object satisfies the object search information; and
determining the third candidate object as the target object in response to the information of the third candidate object satisfying the object search information.

8. The method according to claim 7, wherein the third candidate object set comprises a candidate object, and the determining whether information of the third candidate object satisfies the object search information comprises:
obtaining information of the candidate object;
sending object determination information to a third model, wherein the object determination information is obtained based on the object search information and the information of the candidate object; and
receiving object determination result information sent by the third model, wherein the object determination result information indicates whether the information of the candidate object satisfies the object search information.

9. The method according to claim 1, wherein the object display information comprises summary information of the at least one target object, and before the object display information is sent, the method further comprises:
obtaining information of the at least one target object; and
summarizing information of each of the at least one target object to determine summary information of each of the at least one target object.

10. The method according to claim 9, wherein the at least one target object comprises a first target object, and the determining summary information of each of the at least one target object comprises:
determining first-type display information and second-type display information based on information of the first target object, wherein a length of the second-type display information is greater than a length of the first-type display information;
summarizing the second-type display information; and
determining summary information of the first target object based on the first-type display information and the second-type display information that is summarized.

11. The method according to claim 10, wherein the summarizing the second-type display information comprises:
sending original display information to a fourth model, wherein the original display information is determined based on the second-type display information; and
receiving display summary information sent by the fourth model, wherein the display summary information comprises the second-type display information that is summarized.

12. A data processing method, comprising:
receiving a target message in a target conversation, wherein the target message comprises object search information;
determining at least one target object based on the object search information, wherein the target object is matched with the object search information; and
displaying a reply message in the target conversation, wherein the reply message comprises object display information, and the object display information is determined based on information of the at least one target object.

13. The method according to claim 12, wherein the reply message comprises text reply content and an object information list, wherein the object information list is used to display the information of the at least one target object.

14. The method according to claim 13, wherein the object information list comprises at least one information card, wherein the information card is used to display information of one of the at least one target object.

15. The method according to claim 13, wherein the at least one target object comprises N target objects, wherein N is a positive integer greater than 1; the object information list is used to display information of M target objects, and the reply message further comprises an object expand control; and the method further comprises:
displaying information of K target objects in the target conversation in response to a first operation triggered for the object expand control, wherein K is a positive integer, and a sum of M and K is not greater than N.

16. The method according to claim 15, wherein the displaying information of K target objects in the target conversation comprises:
displaying the information of the K target objects in the reply message in response to the first operation triggered for the object expand control; or displaying expand information in the target conversation, wherein the expand information is used to display the information of the K target objects.

17. An electronic device, comprising:
one or more processors; and
a storage apparatus, on which one or more programs are stored, wherein
the one or more programs, when executed by the one or more processors, cause the one or more processors to implement:
obtaining object search information;
sending intention analysis information to a first model, wherein the intention analysis information is generated based on the object search information;
receiving intention information sent by the first model, wherein the intention information is determined based on the object search information; and
generating object display information, wherein the object display information is determined based on information of at least one target object, the target object is determined based on the intention information, and the target object is matched with the object search information.

18. The electronic device according to claim 17, wherein after the intention information is received and before the object display information is sent, the one or more programs, when executed by the one or more processors, further cause the one or more processors to implement:
determining condition information based on the intention information; and
determining the at least one target object based on the condition information, wherein the information of the target object is matched with the condition information.

19. The method according to claim 17, wherein the object display information comprises summary information of the at least one target object, and before the object display information is sent, the one or more programs, when executed by the one or more processors, further cause the one or more processors to implement:
obtaining information of the at least one target object; and
summarizing information of each of the at least one target object to determine summary information of each of the at least one target object.

20. A computer-readable storage medium, on which computer programs are stored, wherein the computer programs, when executed by a processor, implement the method according to claim 1.
